(19) United States
(12) Patent Application Publication
(10) Pub. No.: US 2019/0232372 A1
(43) Pub. Date: Aug. 1, 2019

(54) METHOD FOR THE TOOL-FREE REMOVAL OF SUPPORT STRUCTURES IN THE ADDITIVE MANUFACTURING OF COMPONENTS

(71) Applicant: FRAUNHOFER-GESELLSCHAFT ZUR FOERDERUNG DER ANGEWANDTEN FORSCHUNG E.V., Muenchen (DE)

(72) Inventors: TOBIAS SCHMITHUESEN, Aachen (DE); FLORIAN EIBL, Aachen (DE); WILHELM MEINERS, Aachen (DE)

(21) Appl. No.: 16/338,049

(22) PCT Filed: Oct. 17, 2017
(86) PCT No.: PCT/EP2017/076492

§ 371 Date: Mar. 29, 2019

(30) Foreign Application Priority Data
Oct. 20, 2016 (DE) 10 2016 220 623.0

(51) Int. Cl. B22F 3/105

(52) U.S. Cl. CPC B22F 3/1055; B29C 64/40

(57) ABSTRACT

The present invention relates to a method for the tool-free removal of support structures in the additive manufacturing of one or more components. The components are built in layers together with support structures for supporting regions of the components, and the support structures are removed from the components after a complete construction of the components. The support structures are constructed in such a manner that they have target separation points at a transition to the components, which have a structure that breaks down more rapidly by chemical or electrochemical reaction compared to component parts. The support structures are then separated from the components by chemical or electrochemical breakdown of the structure at the target separation points. With this tool-free removal of the support structures, the components can be both arranged in parallel and also completely automatically processed.

### TECHNICAL FIELD OF APPLICATION

The present invention relates to a method for the tool-free removal of support structures in the additive manufacturing of one or more components, in particular by means of selective laser melting or laser sintering in which the components together with support structures for supporting regions of the components are built up in layers and the support structures are removed from the components after a complete construction of the components, wherein the support structures are constructed in such a manner that they have target separation points at a transition to the components.

In additive manufacturing methods, components are fabricated in layers directly from 3D CAD models. Examples of additive manufacturing methods are stereolithography, so-called fused deposition modelling, selective laser melting or selective laser sintering. In powder-bed-based beam melting methods such as, for example, laser beam melting (LBM: laser beam melting), the three-dimensional components are built in layers by a repetitive process from layered application of a thin powder layer having a thickness of less than 200 μm and subsequent selective fusing of specific regions of this powder layer by laser radiation according to the geometry information of the 3D CAD model. By this means, three-dimensional components of almost unlimited complexity can be produced. A building platform on which the powder layers can be deposited successively serves as the basis of the powder-bed-based beam melting method. The laser radiation is guided, for example with the aid of galvanometer scanners over the respectively deposited layers.

### PRIOR ART

A method for selective laser melting of high-melting metallic material powers is known, for example, from DE 196 49 865 C1. In this method the component is built up in layers by repeated application of a layer of material powder and complete melting of the layer with a laser beam on a substrate plate. In this case however, considerable forces occur inside the component during building up which in the case of overhanging geometries can result in increased warpage of the component. Depending on the method therefore, support structures must be additionally built up during the building process in order on the one hand to counteract thermally induced stresses and thus prevent warpage of the component and on the other hand to ensure that overhanging surfaces can be built over. These support structures must then be removed again following manufacture after the components have been completely built up.

Hitherto these support structures are usually removed in a manual processing step, for example, by means of simple hand tools such as hammers and chisels or pliers.

EP 0 655 317 A1 discloses a method in which an interface is produced between the support structures and the components, which has structures with reduced cross-section in order to reduce the linkage between the support structures and the components. The support structures can thus be separated mechanically from the component more easily and at a defined point.

As a result of the manual processing for the removal of the support structures, the final processing process in the additive manufacture of components is however very time-consuming and costly and therefore not economical for series production. Furthermore, as a result of the usually tool-bound processing, support structures which are difficult to access such as, for example, to support cooling ducts cannot be removed or only with considerable effort.

The object of the present invention consists in providing a method for the removal of support structures in the additive manufacturing of components which enables a tool-free and automatable removal of the support structures.

### DESCRIPTION OF THE INVENTION

The object is solved by the method according to patent claim 1. Advantageous embodiments of the method are the subject matter of the dependent patent claims or can be deduced from the following description and the exemplary embodiments.

In the proposed method one or more components are built up in layers together with support structures for supporting regions of the components. This is preferably accomplished by a powder-bed-based beam melting method such as, for example laser beam melting or laser sintering, in which the component or components are built up in layers on a substrate plate or building platform by repeated application of a layer of preferably metallic material powder and fusing of the layer with a laser beam. The support structures are in this case built up in such a manner that they have target separation points at a transition to the component. These target separation points are configured so that they have a structure which can be broken down more rapidly by chemical or electrochemical reaction, in particular by chemical or electrochemical etching, compared with all the component parts and preferably also other parts of the support structures. In the proposed method, after complete construction of the component or the components, the support structures are then separated from the components by chemical or electrochemical breakdown of the structure at the target separation points. This therefore involves the process of chemical or electrochemical removal. The target separation points in this case have an extension which allows sufficient access of an agent used for the chemical or electrochemical removal of the structure, for example, an etchant.

In the proposed method after the complete construction of the components, the support structures are broken down chemically or electrochemically at least locally at the target separation points and the component is thus separated from the support structures. Depending on the configuration of the support structures, these can also be broken down chemically or electrochemically at other points or completely. The breakdown is preferably accomplished by chemical or electrochemical etching whereby the component or the components with the support structures are dipped into a suitable etchant. In the preferred configuration no pre-treatment of the surface of the support structures is carried out to increase sensitivity of the surface for the etching process.

The target separation points are preferably formed with a structure for which the ratio between the circumference which can be wetted with etchant U_{support,wetted} and the appurtenant cross-sectional area, i.e. forming the basis of the circumference, Aₛᵤₚₚₒᵣₜ (cf. FIG. 2) at each target separation point is greater than the largest ratio between the circumference which can be wetted with the etchant U_{component,wetted} and the appurtenant cross-sectional area A_{component} at each component part. It is thereby achieved that the target separation points are broken down or etched more rapidly than other points of the component or components and the support structures. This rule is specified in the following formula:

$$\frac{{U}_{support , wetted}}{{A}_{support}} > \frac{{U}_{component , wetted}}{{A}_{component}}$$

Such a support structure can be achieved, for example, whereby the support structures branch in a tree-like manner at the transition to the component. The ratio between the circumference wetted with etchant U_{support,wetted} and the appurtenant cross-sectional area Aₛᵤₚₚₒᵣₜ at constant cross-section increases in this case, for example, linearly with the number of branches.

In order to ensure dimensional accuracy, the respective component can also be provided or built up with a defined oversize. This oversize is selected so that after the chemical or electrochemical breakdown of the structure at the target separation points, the component or components have the desired dimensions. In this case, it is taken into account that as a result of the agent used for the chemical or electrochemical breakdown of the structure at the target separation points, regions of the component are also broken down or etched away.

In the additive manufacturing of components, the support structures are, for example, built up underneath component overhangs. They can also be built up on a substrate plate for building the components and/or between individual regions of the components. The arrangement of the individual support structures is usually selected by means of an overhang angle which should not be fallen below and is dimensioned in such a manner that the support structure does not tear away from the component at any point. In this case, the entire component can also be built on support structures so that it has no direct contact with the substrate plate or building platform. This enables easy removal of the substrate plate (with the support elements) from the finished component. The support structures can in this case have any geometries, for example, they can be built in cylindrical, rectangular, conical or plate-shaped geometry or have a grid-like or tree-like structure.

The proposed method enables the automated tool-free removal of support structures of additively manufactured components. Since the removal in particular requires no dimensionally stable tools, interior support structures can also be removed without any problems. Due to the tool-free removal, the components can on the one hand be parallelized and on the other hand be processed in a completely automated manner for example by using conveyor belts between individual tanks containing the etchants used. The method is particularly suitable for powder-bed-based beam melting methods and makes it possible to achieve industrial series production, the possibility of continuous production and the reduction of non-productive times within the manufacturing process. With the method the final processing time and the associated costs are drastically reduced as a result of the possibility of the simultaneous automated processing of almost arbitrarily complex components. By means of the tool-free processing, not only support structures on arbitrarily complex-shaped outer surfaces can be removed in a defined manner but also in difficult-to-access interior structures such as, for example, cooling ducts. By means of the proposed method geometrically different components can be finally processed at the same time without the final processing system needing to be retrofitted. As a result of the application of the proposed method, the surface roughness of the entire component can also be demonstrably reduced by local removal of roughness peaks. The processing time according to the proposed method does not correlate with the complexity of the component. By means of the tool-free processing the component to be processed does not experience any mechanical effect so that any accidental damage to the surface of the component by a tool can be eliminated. The removal of the support structures by means of the proposed method can also be accomplished within a few minutes.

The method can be used particularly for the final processing of components which are manufactured by means of powder-bed-based additive manufacturing, for example, by a selective laser beam melting method. The method is not restricted to the number of the geometrical complexity of the components, the powder material used and a specific etchant.

### BRIEF DESCRIPTION OF THE DRAWINGS

The proposed method is explained in detail once again hereinafter with reference to an exemplary embodiment in conjunction with the drawings. In this case,

FIG. 1 shows a schematic diagram of a component with support structures built on a building platform using an additive manufacturing method;

FIG. 2 shows a schematic diagram of an exemplary target separation point and the appurtenant wettable circumference and the cross-sectional area; and

FIG. 3 shows an example for the process sequence during the removal of support structures from the component.

### WAYS FOR IMPLEMENTING THE INVENTION

In the following the proposed method is described by means of the manufacture of a component using a powder-bed-based additive manufacturing method. In this manufacturing method support structures are built at the same time as the component to avoid warpages and to ensure that building over is possible. Following the additive manufacturing process, for example a laser beam melting process, these support structures must then be removed again from the component in a final processing.

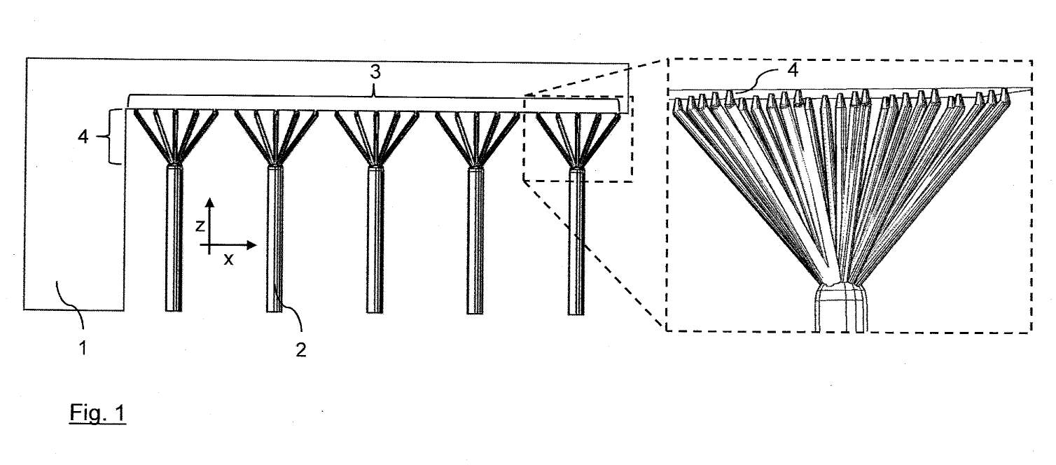

FIG. 1 shows as an example for this a completely built component 1 which has an overhang region 3 which is supported by a support structure 2. The support structure 2 was built in layers together with the component 1 in an additive manufacturing process. The support structure 2 is designed so that at the transition to the overhang region 3 of the component 1 it has target separation points 4. These target separation points have a structure whose ratio of wettable circumference to the appurtenant cross-sectional area is greater than the same ratio at all other points of the component 1 and the support structure 2.

In the example of FIG. 1 five tree-like support elements are used as support structures which branch in a tree-like manner in the region of the target separation points 4. The individual branches in this case have a substantially larger ratio of wettable circumference to appurtenant cross-sectional area than the trunk-like region of the respective support element located thereunder and the entire component.

These branches could already serve as target separation points. In the present example however these branches additionally taper at the transition to component 1 with the result that the target separation points 4 are formed here. The ratio of wettable circumference to appurtenant cross-sectional area at these target separation points 4 is substantially greater than that at each branch element, with the result that the separation of the positive connection between component and support structure can be achieved specifically at this point. Furthermore, this enables a rapid breakdown of the structure at the target separation points 4 by means of an etchant without hereby also removing larger regions of the component 1. Optionally the component 1 can also be provided with a defined oversize so that after the etching process the originally desired dimension of the component 1 is achieved.

FIG. 2 shows an exemplary diagram of a target separation point 4 of a support structure 2 such as that of FIG. 1 at a component 1. The ratio between the circumference which can be wetted with etchant U_{support,wetted} and the appurtenant cross-sectional area Aₛᵤₚₚₒᵣₜ at the target separation point 4 is greater than the largest ratio between the circumference which can be wetted with etchant and the appurtenant cross-sectional area at each component part.

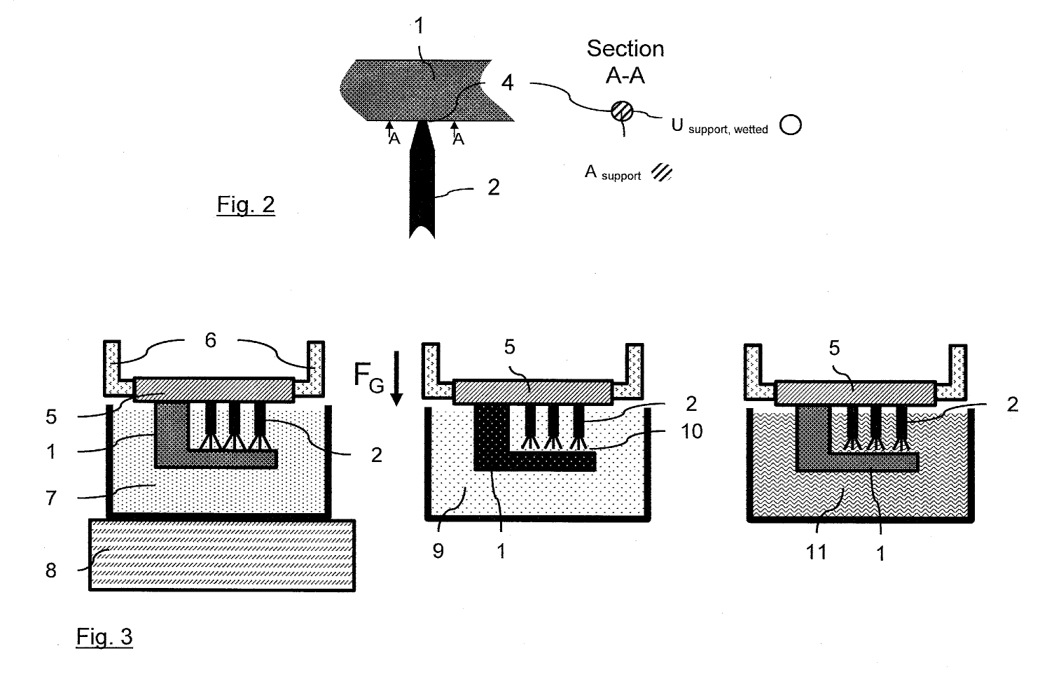

A simple etchant-resistant heatable basin 7 in which the etchant is located can be used for application of the proposed method. When using a material powder of, for example, AlSi10Mg to build up the components, for example sodium hydroxide (NaOH) can be used as etchant. This is shown schematically in FIG. 3 which shows three steps for removing the support structures. In the first step (left part diagram) the component 1 located on the building platform 5 with the support structures 2 is dipped into the basin 7 by means of a holding device 6 or is placed completely in the basin 7 containing the etchant as component 1 with support structures 2 already separated from the building platform 5. The etchant thereby rapidly etches away the support structures 2 at the target separation points 4 as a result of the large ratio of wetted circumference to appurtenant cross-section area. The etching process can also be accelerated by increasing the temperature of the etchant to, for example, 80° C. by means of a heating device 8 on which the basin 7 containing the etchant sits.

After successful separation of the support structure 2, the component 1 is dipped into another basin 9 containing a neutralizing agent (for example, water) in order to stop the etching process. This is shown schematically in the middle part diagram in FIG. 3. The local separation 10 of the support structure 2 at the transition to the component 1 is also indicated in this part diagram.

The oxide layers which also form on the component surface due to the etching process in this method can be removed in a third step, for example, by means of an ultrasound bath 11. To this end, in this last third step the component 1 is dipped into the ultrasound bath 11 as shown schematically in the right part diagram in FIG. 3. After application of the proposed method, the component 1 already has a surface quality on the previously supported surface which at least corresponds to the surface quality of a manually processed component.

### REFERENCE LIST

1 Component
2 Support structure
3 Overhang region of component
4 Target separation point
5 Building platform
6 Holding device
7 Basin containing etchant
8 Heating device
9 Basin containing neutralizing agent
10 Local separation of support structure
11 Ultrasound bath

1. Method for the tool-free removal of support structures in the additive manufacturing of one or more components, in particular by means of laser beam melting or laser sintering in which the components are built up in layers together with the support structures for supporting regions of the components and the support structures are removed from the components after the complete construction of the components, wherein the support structures are built up in such a manner that they have target separation points at a transition to the components, characterized in that the target separation points are configured so that they have a structure which can be broken down more rapidly by to chemical or electrochemical reaction compared to component parts, and that the support structures are separated from the components by chemical or electrochemical breakdown of the structure at the target separation points.

2. The method according to claim 1, characterized in that the target separation points are formed with a structure which has a larger ratio of circumference which can be wetted with etchant to appurtenant cross-sectional area than the component parts.

3. The method according to claim 2, characterized in that the target separation points are formed with a structure which has a larger ratio of circumference which can be wetted with etchant to appurtenant cross-sectional area than other parts of the support structures.

4. The method according to claim 1, characterized in that after complete construction of the components, the components with the support structures are dipped in a chemical or electrochemical etchant in order to break down the structure at the target separation points by an etching process.

5. The method according to claim 4, characterized in that after breakdown of the structure at the target separation points the etching process is stopped with a neutralizing agent.

6. The method according to claim 5, characterized in that oxide layers forming on the components due to the etching process are removed by means of an ultrasound bath.

7. The method according to claim 4, characterized in that the components are built up with an oversize which is selected in such a manner that after the chemical or electrochemical breakdown of the structure at the target separation points the final dimensions of the components lie within a predefined tolerance.

8. The method according to claim 1, characterized in that the support structures are built up at least below component overhangs.

9. The method according to claim 1, characterized in that the support structures are built up on a substrate plate for building up the components and/or between individual regions of the components.

10. The method according to claim 1, characterized in that the support structures are built up so that they branch off in a tree-like manner at the transition to the components.

11. The method according to claim 3, characterized in that the support structures are built up so that they branch off in a tree-like manner at the transition to the components.
